(19) United States
(12) Patent Application Publication
(10) Pub. No.: US 2025/0343348 A1
(43) Pub. Date: Nov. 6, 2025

(54) ANTENNA APPARATUS AND WIRELESS MOBILE TERMINAL

(71) Applicant: Yungu (Gu’an) Technology Co., Ltd., Langfang (CN)

(72) Inventor: Huan-Chu HUANG, Langfang (CN)

(73) Assignee: Yungu (Gu’an) Technology Co., Ltd., Langfang (CN)

(21) Appl. No.: 19/271,690

(22) Filed: Jul. 16, 2025

(30) Foreign Application Priority Data
Jul. 31, 2024 (CN) 202411045179.2

(51) Int. Cl. H01Q 1/24; H01Q 1/52

(52) U.S. Cl. CPC H01Q 1/243; H01Q 1/526

(57) ABSTRACT

Embodiments of the present application provide an antenna apparatus and a wireless mobile terminal. The antenna apparatus includes: a frame enclosing a hollow space and including a first segment extending in a first direction; a bracket connected to a side of the first segment in a second direction and located in the hollow space, an extension dimension of the bracket in the first direction being greater than an extension dimension thereof in the second direction; and an antenna assembly including a first antenna module, materials of the bracket and the first segment each including a conductive material and doubling as at least part of the first antenna module.

### CROSS-REFERENCE TO RELATED APPLICATIONS

The present application claims priority to Chinese Patent Application No. 202411045179.2, filed on Jul. 31, 2024 and entitled “ANTENNA APPARATUS AND WIRELESS MOBILE TERMINAL”, the disclosure of which is incorporated herein by reference in its entirety.

### FIELD

The present application relates to the field of electronic devices, and in particular to an antenna apparatus and a wireless mobile terminal.

### BACKGROUND

The functions of wireless communication devices (such as mobile phones and smart watches) have been evolving rapidly, and market demands on the appearance and the wireless communication performance of apparatuses are also constantly increasing. How to improve the communication performance of wireless mobile terminals thus has become an urgent problem to be solved.

### SUMMARY

Embodiments of the present application provide an antenna apparatus and a wireless mobile terminal, which are intended to improve the wireless communication performance of the wireless mobile terminal.

The embodiments of a first aspect of the present application provide an antenna apparatus, including: a frame enclosing a hollow space and including a first segment extending in a first direction; a bracket connected to a side of the first segment in a second direction and located in the hollow space, an extension dimension of the bracket in the first direction being greater than an extension dimension thereof in the second direction; and an antenna assembly including a first antenna module, materials of the bracket and the first segment each including a conductive material and doubling as at least part of the first antenna module.

The embodiments of a second aspect of the present application also provide a wireless mobile terminal, including the antenna apparatus as described in any one of the embodiments of the first aspect.

In the antenna apparatus provided by the present application, the antenna apparatus includes the frame, the bracket and the antenna assembly. The frame may enclose the hollow space for accommodating the antenna assembly and the bracket, and the bracket is connected to the first segment of the frame and located in the hollow space to provide an installation position for the antenna assembly. The antenna assembly includes a first antenna module and a second antenna module, and antenna functions can be enriched. The wireless communication performance of the wireless mobile terminal can be improved when the antenna apparatus is used for the wireless mobile terminal. The antenna assembly includes the first antenna module, and the materials of the bracket and the first segment each include a conductive material and double as at least part of the first antenna module, and the size of the space occupied by the first antenna module can be reduced, and the bracket can also be used for supporting other components to facilitate the arrangement of other parts inside the hollow space. In addition, in the embodiments of the present application, the bracket is located on the side of the first segment in the second direction, and the extension dimension of the bracket in the first direction is greater than the extension dimension thereof in the second direction, i.e., a length direction of the bracket is parallel to a length direction of the first segment, to facilitate closer positioning of the whole bracket to the first segment, and antenna radiation may be directed toward a top end to improve the wireless signal transmitting and receiving capability toward the top end and strengthen the performance of wireless communication between the mobile terminal and a satellite. Therefore, the embodiments of the present application can improve the wireless communication performance of the wireless mobile terminal.

### BRIEF DESCRIPTION OF THE DRAWINGS

By reading the following detailed description of non-limiting embodiments made with reference to the drawings, the other features, objectives and advantages of the present application will become more apparent, in which the same or similar features are denoted by the same or similar reference signs.

FIG. 1 is a schematic structural diagram of an antenna apparatus according to an embodiment of the present application;

FIG. 2 is a partially enlarged schematic structural diagram of the antenna apparatus according to an embodiment of the present application;

FIG. 3 is a partially enlarged schematic structural diagram of the antenna apparatus according to another embodiment of the present application;

FIG. 4 is a partially enlarged schematic structural diagram of the antenna apparatus according to still another embodiment of the present application;

FIG. 5 is a partially enlarged schematic structural diagram of the antenna apparatus according to yet another embodiment of the present application;

FIG. 6 is a partially enlarged schematic structural diagram of the antenna apparatus according to a further embodiment of the present application;

FIG. 7 is a partially enlarged schematic structural diagram of the antenna apparatus according to a still further embodiment of the present application; and

FIG. 8 is a partially enlarged schematic structural diagram of the antenna apparatus according to a yet further embodiment of the present application.

List of reference signs:
10. Antenna apparatus;
100. Frame; 110a. Segment; 110. First segment; 111. Third side face; 120. Hollow space; 130. Base plate;
210. Bracket; 211. Second side face; 220. Reflective wall; 230. Connecting portion; 231. First side face; 240. Extension portion; 241. Fourth side face; 250. Grounding portion;
300. Antenna assembly; 301. First antenna module, 302. Second antenna module, 310. Second antenna element; 320. Substrate; 321. First region; 322. Second region; 330. Second integrated circuit; 340. Shield; 350. Connection terminal;
Y. First direction; X. Second direction; Z. Third direction.

### DETAILED DESCRIPTION OF THE EMBODIMENTS

The features and exemplary embodiments of the present application in various aspects are described in detail below. In the following detailed description, many specific details are set forth to comprehensively understand the present application. However, it will be very apparent in the art that the present application may be implemented without some of these specific details. The following description of the embodiments are merely to provide a better understanding for the present application by illustrating examples of the present application. In the drawings and the following descriptions, at least part of known structures and techniques are not shown to avoid unnecessary ambiguousness of the present application; and for the sake of clarity, the dimensions of some structures may be exaggerated. In addition, the features, structures, or characteristics described below may be combined, in any suitable manner, in one or more embodiments.

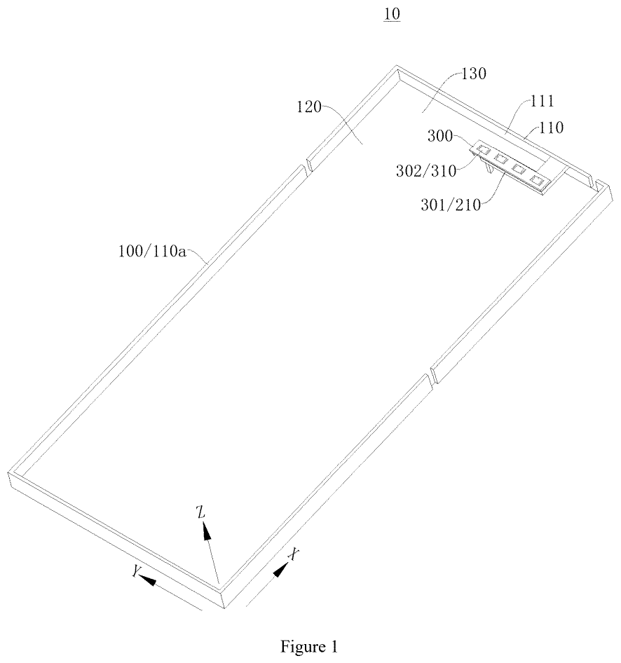

In order to better understand the present application, an antenna apparatus 10 and a wireless mobile terminal according to the embodiments of the present application will be described in detail below with reference to FIGS. 1 to 8.

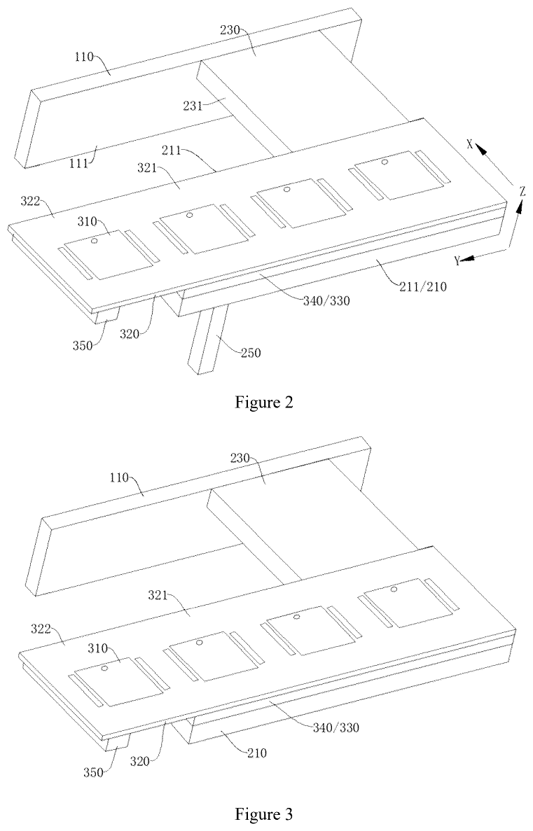

Referring to FIGS. 1 to 2 together, FIG. 1 is a schematic structural diagram of an antenna apparatus 10 according to an embodiment of the present application, and FIG. 2 is a partially enlarged schematic structural diagram of the antenna apparatus 10 according to an embodiment of the present application.

As shown in FIGS. 1 and 2, an embodiment of a first aspect of the present application provides an antenna apparatus 10. The antenna apparatus 10 includes: a frame 100 enclosing a hollow space 120 and including a first segment 110 extending in a first direction Y; a bracket 210 connected to a side of the first segment 110 in a second direction X and located in the hollow space 120, an extension dimension of the bracket 210 in the first direction Y being greater than an extension dimension thereof in the second direction X; and an antenna assembly 300 including a first antenna module 301, materials of the bracket 210 and the first segment 110 each including a conductive material and doubling as at least part of the first antenna module 301.

In the antenna apparatus 10 provided by the present application, the antenna apparatus 10 includes the frame 100, the bracket 210 and the antenna assembly 300. The frame 100 may enclose the hollow space 120 for accommodating the antenna assembly 300 and the bracket 210, and the bracket 210 is connected to the first segment 110 of the frame 100 and located in the hollow space 120 to provide an installation position for the antenna assembly 300. The materials of the bracket 210 and the first segment 110 each include a conductive materials and double as at least part of the first antenna module 301, and the size of the hollow space 120 occupied by the first antenna module 301 can be reduced, and the bracket 210 can also be used for supporting other components to facilitate the arrangement of other parts inside the hollow space 120. In addition, in the embodiments of the present application, the bracket 210 is located on the side of the first segment 110 in the second direction X, and the extension dimension of the bracket 210 in the first direction Y is greater than the extension dimension thereof in the second direction X, i.e., a length direction of the bracket 210 is not perpendicular to a length direction of the first segment 110, and the bracket 210 has a larger dimension in the first direction Y, to facilitate closer positioning of the whole bracket 210 to the first segment 110 to enable relatively concentrated distribution of current near the first segment 110, and antenna radiation may be directed toward a top end to improve the wireless signal transmitting and receiving capability toward the top end and strengthen the performance of wireless communication between the mobile terminal and a satellite. Therefore, the embodiments of the present application can improve the wireless communication performance of the wireless mobile terminal. In one embodiment, an included angle between the length direction of the bracket 210 and the first direction Y may be greater than or equal to 0 degrees and less than 45 degrees. The length direction of the bracket 210 may be a line that connects two ends with the maximum extension dimension of the bracket 210. The embodiments of the present application are illustrated by taking the length direction of the bracket 210 as the first direction Y. In other embodiments, the length direction of the bracket 210 may not be the first direction Y as long as the extension dimension of the bracket 210 in the first direction Y is greater than the extension dimension thereof in the second direction X.

In one embodiment, the antenna apparatus 10 is used for a wireless mobile terminal, and the wireless mobile terminal may further include a control mainboard and other parts. The control mainboard may be arranged in the hollow space 120. In one embodiment, the frame 100 may be a middle frame of the wireless mobile terminal, and the frame 100 is arranged around the wireless mobile terminal.

In one embodiment, the frame 100 may be integrally formed, i.e., the integrally formed closed annular frame 100 encloses the hollow space 120.

In other embodiments, the frame 100 may further include a plurality of segments 110a. The plurality of segments 110a include a first segment 110, and the plurality of segments 110a are arranged around the hollow space 120. In one embodiment, adjacent segments 110a are insulated from each other. For example, an insulating spacer layer is arranged between the adjacent segments 110a to alleviate the influence of the frame 100 on wireless signal transmission of the wireless mobile terminal, thereby improving the antenna performance. The embodiments of the present application are illustrated by taking the frame 100 including the plurality of segments 110a as an example.

The bracket 210 may be configured in various ways, and the bracket 210 may be in the shape of a plate, a block, a column, etc. In one embodiment, the bracket 210 is in the shape of a plate to reduce the space occupied by the bracket 210.

In one embodiment, the antenna apparatus 10 further includes a base plate 130, and the frame 100 is connected to a peripheral side of the base plate 130 and encloses the hollow space 120 together with the base plate 130. In one embodiment, a distance between a surface of the bracket 210 facing away from the base plate 130 and the base plate 130 is less than or equal to a distance between a surface of the frame 100 facing away from the base plate 130 and the base plate 130, i.e., the surface of the bracket 210 facing away from the base plate 130 is arranged closer to the base plate 130 than the frame 100 in a third direction Z. The bracket 210 does not protrude from the frame 100 in a direction away from the base plate 130 in the third direction Z, and the overall size of the antenna apparatus 10 can be reduced.

In one embodiment, the base plate 130 and the control mainboard of the wireless mobile terminal may double as each other. Alternatively, the base plate 130 and the control mainboard may be arranged independent of each other.

In some embodiments, as shown in FIG. 2, a grounding portion 250 is connected to the bracket 210, the grounding portion 250 abuts between the base plate 130 and the bracket 210, and the grounding portion 250 is electrically connected to the bracket 210 and the base plate 130. The bracket 210 is electrically connected to the base plate 130 by means of the grounding portion 250, and the bracket 210 may share a ground potential with the base plate 130.

In other embodiments, the grounding portion 250 may not abut against the base plate 130.

Alternatively, as shown in FIG. 3, the bracket 210 and the base plate 130 are spaced apart from each other, i.e., the bracket 210 is suspended relative to the base plate 130, and an exposed area of the base plate 130 can be increased.

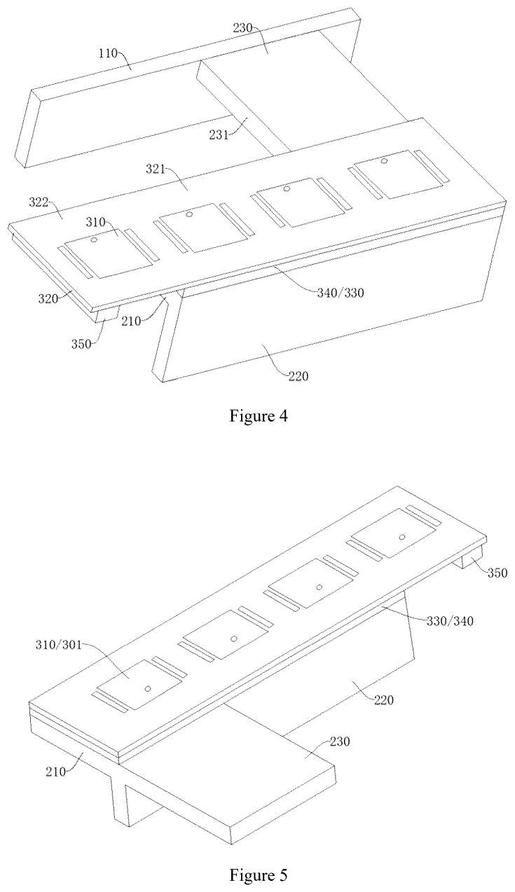

In some embodiments, as shown in FIGS. 4 and 5, a reflective wall 220 is arranged on a side of the bracket 210 facing toward the base plate 130. A wireless signal on the first segment 110 may be reflected by the reflective wall 220, thereby improving the performance (e.g., radiation gain) of the first antenna module 301 and the wireless performance of the mobile terminal.

There may be various relative positional relationships between the reflective wall 220 and the bracket 210. In one embodiment, the reflective wall 220 is connected to a side of the bracket 210 close to or away from the first segment 110. By appropriately adjusting the position of the reflective wall 220, for example, as shown in FIG. 4, by arranging the reflective wall 220 on the side of the bracket 210 close to the first segment 110 to reduce a distance between the reflective wall 220 and the first segment 110, or as shown in FIG. 5, by arranging the reflective wall 220 on the side of the bracket 210 away from the first segment 110 to increase the distance between the reflective wall 220 and the first segment 110, the strength of reflection to wireless signal lines in different frequency bands on the first segment 110 by the reflective wall 220 can be adjusted.

In one embodiment, an extension dimension of the reflective wall 220 in the first direction Y equals the extension dimension of the bracket 210 in the first direction Y. Making the reflective wall 220 large enough can enhance the function of the reflective wall 220.

In other embodiments, the extension dimension of the reflective wall 220 in the first direction Y may equal a dimension of the first segment 110 in the first direction Y, and wireless signals at different positions on the first segment 110 can be all reflected by the reflective wall 220.

In one embodiment, the extension dimension of the reflective wall 220 in the first direction Y may be less than the extension dimension of the bracket 210 in the first direction Y.

In one embodiment, the reflective wall 220 and the base plate 130 are spaced apart from each other, and more surface of the base plate 130 is exposed. Alternatively, the reflective wall 220 abuts between the base plate 130 and the bracket 210 to improve the positional stability of the reflective wall 220. In one embodiment, the reflective wall 220 may be connected to the base plate 130, and the reflective wall 220 is used for grounding.

In one embodiment, the reflective wall 220 and the bracket 210 are integrally formed to improve the stability of the relative position between the reflective wall 220 and the bracket 210.

In some embodiments, as shown in FIGS. 1 to 5, the antenna apparatus 10 further includes a connecting portion 230. The connecting portion 230 has one end connected to the first segment 110 and the other end connected to the bracket 210, and the bracket 210 and the first segment 110 are spaced apart from each other in the second direction X.

In these embodiments, the bracket 210 is connected to the first segment 110 by means of the connecting portion 230, and a distance between the bracket 210 and the first segment 110 can be adjusted by reasonably adjusting a length of the connecting portion 230.

In one embodiment, an extension dimension of the connecting portion 230 in the second direction X is smaller than the extension dimension of the bracket 210 in the first direction Y. A current flow distance between the bracket 210 and the first segment 110 can be extended when current on the bracket 210 flows to the first segment 110 through the connecting portion 230, to improve the performance of the first antenna module 301, and the first antenna module 301 can cover a lower frequency band.

In one embodiment, the connecting portion 230 extends in the second direction X. The bracket 210 and the first segment 110 are spaced apart from each other in the second direction X, and the connecting portion 230 extends in the second direction X, and an extension distance of the connecting portion 230 can be appropriately reduced to correspondingly adjust the covered frequency band (especially a low frequency band).

In one embodiment, the first direction Y is perpendicular to the second direction X. The bracket 210, the connecting portion 230 and the first segment 110 may be arranged horizontally and vertically, to simplify the structure of the antenna apparatus 10.

In one embodiment, the connecting portion 230 and the bracket 210 are integrally formed. The stability of connection between the connecting portion 230 and the bracket 210 can thus be improved.

In some embodiments, the connecting portion 230 includes two first side faces 231 oppositely arranged in the first direction Y, the bracket 210 includes a second side face 211 facing toward the first segment 110, an included angle between an orthographic projection of the first side face 231 in the third direction Z and a projection of the second side face 211 in the third direction Z is 90 degrees, and the third direction Z is perpendicular to both of the first direction Y and the second direction X.

In these embodiments, the first side face 231 and the second side face 211 are perpendicular to each other, and the connecting portion 230 and the bracket 210 can be arranged horizontally and vertically, and the structure of the antenna apparatus 10 can thus be simplified.

In some embodiments, the first segment 110 includes a third side face 111 facing toward the bracket 210, and an included angle between the orthographic projection of the first side face 231 in the third direction Z and a projection of the third side face 111 in the third direction Z is 90 degrees.

In these embodiments, the first side face 231 is perpendicular to the third side face 111, and the connecting portion 230 and the first segment 110 can be arranged horizontally and vertically, and the structure of the antenna apparatus 10 can thus be simplified.

In some embodiments, the orthographic projection of the second side face 211 in the third direction Z is parallel to the projection of the third side face 111 in the third direction Z. The structure of the antenna apparatus 10 can thus be simplified.

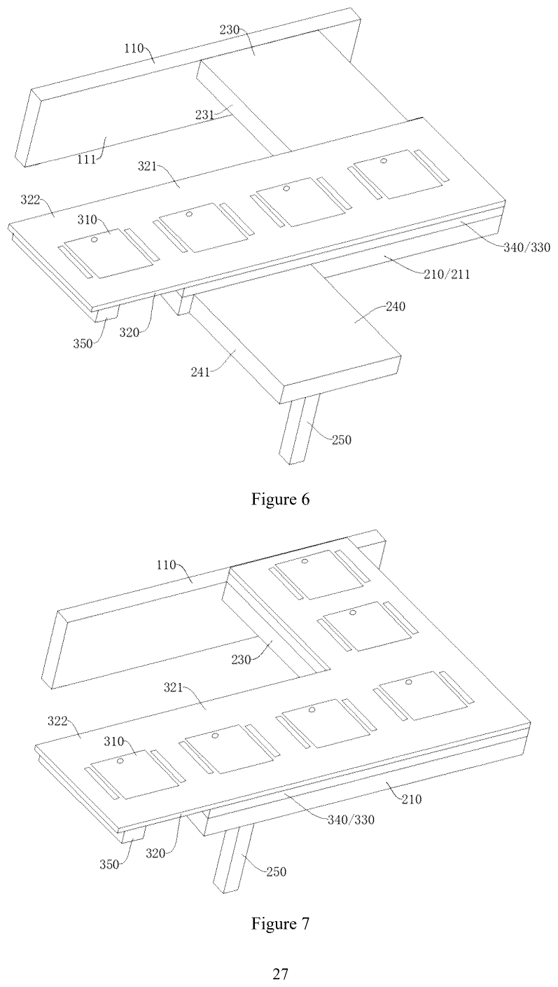

In some embodiments, as shown in FIG. 6, the antenna apparatus 10 further includes an extension portion 240. The extension portion 240 is connected to a side of the bracket 210 facing away from the first segment 110 and extends in a direction away from the first segment 110.

In these embodiments, the extension portion 240 is additionally arranged on the side of the bracket 210 away from the first segment 110, and a distance by which current flows on the extension portion 240 and the bracket 210 can be increased to adjust the performance of the first antenna module 301, and the first antenna module 301 can thus cover a lower frequency band. Current on the first antenna module 301 may also be designed better with a higher degree of freedom to achieve a better antenna performance.

In one embodiment, when the bracket 210 is provided with the extension portion 240, the grounding portion 250 may be connected between the extension portion 240 and the base plate 130, and the grounding portion 250 may be connected to the bracket 210 by means of the extension portion 240. The length of a flow path of the current can also be further increased, and the first antenna module 301 can cover a lower frequency band. In addition, the grounding portion 250 may also change the distribution of current of the base plate 130, and the current of the base plate 130 is more concentrated at an upper end of the base plate 130 in a positive x direction, i.e., more concentrated near the first segment 110, and antenna radiation may be directed toward the top end to improve the wireless signal transmitting and receiving capability toward the top end and strengthen the performance of wireless communication between the mobile terminal and the satellite.

In one embodiment, an extension dimension of the extension portion 240 in the second direction X is smaller than the extension dimension of the bracket 210 in the first direction Y. The current flow distance between the bracket 210 and the first segment 110 is extended, and the performance (e.g., coverage of a low frequency band) of the first antenna module 301 is improved.

In one embodiment, the extension portion 240 and the connecting portion 230 are spaced apart from each other in the first direction Y when the antenna apparatus 10 further includes the connecting portion 230. Therefore, current may flow through the first segment 110, the connecting portion 230, the bracket 210 and the extension portion 240, and the length of the flow path of the current can be further increased to enable the first antenna module 301 to cover a lower frequency band.

In one embodiment, the extension dimension of the extension portion 240 in the second direction X may be the same as or different from the extension dimension of the connecting portion 230 in the second direction X.

In one embodiment, the extension portion 240 and the bracket 210 are integrally formed to improve the stability of connection between the extension portion 240 and the bracket 210.

In one embodiment, the extension portion 240 extends in the second direction X. In one embodiment, the first direction Y is perpendicular to the second direction X. The bracket 210, the extension portion 240 and the first segment 110 may be arranged horizontally and vertically, to simplify the structure of the antenna apparatus 10.

In some embodiments, the extension portion 240 includes two fourth side faces 241 oppositely arranged in the first direction Y, the bracket 210 includes the second side face 211 facing toward the first segment 110, an included angle between an orthographic projection of the fourth side face 241 in the third direction Z and the projection of the second side face 211 in the third direction Z is 90 degrees, and the third direction Z is perpendicular to both of the first direction Y and the second direction X.

In these embodiments, the fourth side face 241 and the second side face 211 are perpendicular to each other, and the connecting portion 230 and the bracket 210 can be arranged horizontally and vertically, and the structure of the antenna apparatus 10 can thus be simplified.

In some embodiments, as shown in FIGS. 1 to 6, the antenna assembly 300 further includes a second antenna module 302 arranged on the bracket 210. The second antenna module 302 includes a plurality of second antenna elements 310.

In these embodiments, by providing the second antenna module 302, the wireless performance of the antenna apparatus 10 can be improved, and the functions and the performance of the antenna apparatus 10 can be enriched.

In one embodiment, the plurality of second antenna elements 310 may be arranged on the bracket 210 in a plurality of rows and columns. The second antenna elements 310 in two adjacent rows may be aligned or misaligned with each other. The embodiments of the present application are illustrated by taking the second antenna elements 310 arranged in a single row as an example.

At least two of the second antenna elements 310 are spaced apart from each other on the bracket 210 in the first direction Y, and by providing the plurality of second antenna elements 310, the signal transmission capability of the second antenna module 302 can be improved, i.e., the antenna performance of the second antenna module 302 can be improved.

In some embodiments, as shown in FIG. 7, at least one of the second antenna elements 310 may be arranged on the connecting portion 230 when the antenna apparatus 10 includes the connecting portion 230. For example, one of the second antenna elements 310 is arranged on the connecting portion 230, or at least two of the second antenna elements 310 are spaced apart from each other on the connecting portion 230 in the second direction X.

In these embodiments, adding one or more second antenna elements 310 to the connecting portion 230 can increase the number of second antenna elements 310 distributed. In addition, two or more second antenna elements 310 are distributed in the length direction of the connecting portion 230, and the number of second antenna elements 310 distributed can be further increased, thereby improving the performance of the second antenna module 302.

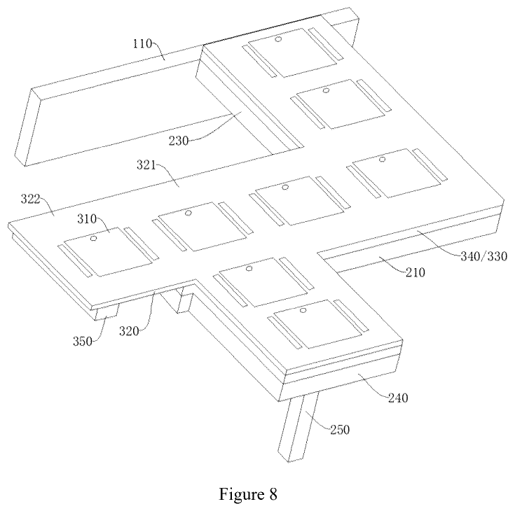

In some embodiments, as shown in FIG. 8, at least one of the second antenna elements 310 may be arranged on the extension portion 240 when the antenna apparatus 10 includes the extension portion 240. For example, one of the second antenna elements 310 is arranged on the extension portion 240, or at least two of the second antenna elements 310 are spaced apart from each other on the extension portion 240 in the second direction X. In these embodiments, adding one or more second antenna elements 310 to the extension portion 240 can increase the number of second antenna elements 310 distributed. In addition, two or more second antenna elements 310 are distributed in the length direction of the extension portion 240, and the number of second antenna elements 310 distributed can be further increased, thereby improving the performance of the second antenna module 302.

Moreover, by adding the plurality of second antenna elements 310 to the connecting portion 230 and/or the extension portion 240, the spatial range of scanning and coverage of antenna radiation beams of the second antenna module 302 can be widened. Therefore, a blind area of wireless communication can be reduced and the user's wireless communication experience can be significantly improved.

The first antenna module 301 and the second antenna module 302 may be configured in various ways. For example, one of the first antenna module 301 and the second antenna module 302 is a millimeter wave antenna module and the other is a non-millimeter wave antenna module, and the antenna assembly 300 can transmit and receive both of a millimeter wave signal and a non-millimeter wave signal.

In some embodiments, the second antenna module 302 is a millimeter wave antenna module, and the second antenna element 310 is configured to transmit and receive a millimeter wave antenna signal. The second antenna element 310 arranged on the bracket 210 has more flexibility in size configuration, and the second antenna element 310 is configured to have an appropriate small size that enables the transmitting and receiving of a millimeter wave antenna signal. And/or, the first antenna module 301 is a non-millimeter wave antenna module, and the first antenna module 301 is configured to transmit and receive a non-millimeter wave antenna signal.

In an embodiment of the present application, when the first antenna module 301 is configured to transmit and receive a non-millimeter wave antenna signal and the second antenna module 302 is configured to transmit and receive a millimeter wave antenna signal, the antenna assembly 300 can transmit and receive both of the millimeter wave signal and the non-millimeter wave signal, and the functions of the antenna assembly 300 can be enriched.

In some embodiments, as shown in FIGS. 1 to 8, the second antenna module 302 includes a substrate 320 and a second integrated circuit 330. The substrate 320 is arranged on the bracket 210, the second antenna elements 310 are located on a side of the substrate 320 facing away from the bracket 210, and the second integrated circuit 330 is located on a side of the substrate 320 facing toward the bracket 210.

In these embodiments, the second antenna module 302 includes the substrate 320, the substrate 320 has the second integrated circuit 330 arranged on one side and the second antenna elements 310 arranged on the other side, and the second antenna elements 310 and the second integrated circuit 330 may be integrated on the bracket 210 by means of the substrate 320.

In addition, since the bracket 210 includes a conductive material, the bracket 210 has a good heat dissipation effect. It is not necessary to provide an additional heat sink component for the second integrated circuit 330, i.e., it is not necessary to provide additional heat dissipation metal for the second integrated circuit 330. Therefore, the cost and the space occupation of a heat sink can be reduced, and the compactness of the overall system design can be enhanced to achieve better overall competitiveness.

In one embodiment, the second antenna module 302 further includes a shield 340. The shield 340 and the substrate 320 are connected to enclose an accommodating cavity, and the second integrated circuit 330 is located in the accommodating cavity.

In these embodiments, the antenna apparatus 10 is further provided with the shield 340, the shield 340 and the substrate 320 together enclose the accommodating cavity, and the second integrated circuit 330 is located inside the accommodating cavity, and the substrate 320 and the shield 340 can provide comprehensive protection for the second integrated circuit 330 to reduce the electromagnetic interference on the second integrated circuit 330 from an external environment or the electromagnetic interference of the second integrated circuit 330 to the external environment, and provide protection of the second integrated circuit 330 against water, dust, collision, etc.

In one embodiment, the antenna assembly 300 further includes a connection terminal 350 arranged on the bracket 210 and connected to the second integrated circuit 330, and the second integrated circuit 330 can be electrically connected to the outside by means of the connection terminal 350 for signal transmission. The connection terminal 350 is arranged on the side of the substrate 320 facing toward the bracket 210, i.e., the connection terminal 350 and the second integrated circuit 330 are spaced apart from each other on the same side of the substrate 320.

In these embodiments, the second integrated circuit 330 may be electrically connected to the outside by means of the connection terminal 350, for example, the second integrated circuit 330 may be electrically connected to the control mainboard of the wireless mobile terminal by means of the connection terminal 350. The arrangement of the connection terminal 350 and the second integrated circuit 330 on the same side of the substrate 320 can reduce a distance between the connection terminal 350 and the second integrated circuit 330 to facilitate electrical connection between the second integrated circuit 330 and the connection terminal 350.

In one embodiment, the connection terminal 350 and the shield 340 are spaced apart from each other in an extension direction of the bracket 210 (i.e., in the first direction Y). When the shield 340 is installed after the second integrated circuit 330 is arranged, the situation where the shield 340 collides with the connection terminal 350 due to an inaccurate installation position can be alleviated.

In one embodiment, the substrate 320 includes a first region 321 and a second region 322 connected to each other. The first region 321 is located on the bracket 210, the second region 322 protrudes from the bracket 210, the second integrated circuit 330 is arranged in the first region 321, and the connection terminal 350 is arranged in the second region 322.

In these embodiments, the connection terminal 350 is arranged in the second region 322, and the connection terminal 350 can extend out of the bracket 210 to facilitate electrical connection between the connection terminal 350 and an external device.

In addition, the second region 322 extending out of the bracket 210 can further extend the length of current and further enhance the signal transmission capability of the first antenna module 301, and the first antenna module 301 can better cover a low frequency band.

As shown in FIGS. 1 to 8, an embodiment of the first aspect of the present application provides an antenna apparatus 10. The antenna apparatus 10 includes: a frame 100 enclosing a hollow space 120 and including a first segment 110 extending in a first direction Y; a bracket 210 connected to a side of the first segment 110 in a second direction X and located in the hollow space 120, a length direction of the bracket 210 being not perpendicular to the first direction Y; and an antenna assembly 300 including a first antenna module 301, materials of the bracket 210 and the first segment 110 each including a conductive material and doubling as at least part of the first antenna module 301.

The length direction of the bracket 210 may be a direction in which the bracket 210 has the maximum extension dimension. For example, as shown in FIG. 1, the bracket 210 may be formed by extending in the first direction Y, and the first direction Y may be the length direction of the bracket 210. This embodiment of the present application differs from the bracket 210 in the above-described embodiments of the present application in that the included angle between the length direction of the bracket 210 and the first direction Y may be greater than or equal to 0 degrees and less than or equal to 180 degrees, and the included angle between the length direction of the bracket 210 and the first direction Y is not 90 degrees. Compared with the solution in which the length direction of the bracket 210 is perpendicular to the first direction Y, a distance between an end of the bracket 210 away from the first segment 110 and the first segment 110 can be reduced, to facilitate closer positioning of the whole bracket 210 to the first segment 110 to enable relatively concentrated distribution of current near the first segment 110, and antenna radiation may be directed toward the top end to improve the wireless signal transmitting and receiving capability toward the top end and strengthen the performance of wireless communication between the mobile terminal and the satellite. Therefore, the embodiments of the present application can improve the wireless communication performance of the wireless mobile terminal.

An embodiment of a second aspect of the present application also provides a wireless mobile terminal, including the antenna apparatus 10 as described in any one of the embodiments of the first aspect. Since the wireless mobile terminal provided by the embodiment of the second aspect of the present application includes the antenna apparatus 10 as described in any one of the above embodiments of the first aspect, the wireless mobile terminal provided by the embodiment of the second aspect of the present application has the beneficial effects of the antenna apparatus 10 of any one of the above embodiments of the first aspect. No detailed description will be given here.

The wireless mobile terminal in the embodiments of the present application includes, but is not limited to, devices having a wireless communication function, such as a mobile phone, a personal digital assistant (PDA), a tablet computer, an e-book reader, a television, an access control system, a smart fixed-line telephone, or a console.

In one embodiment, the wireless mobile terminal further includes a functional device. A housing of the functional device doubles as at least part of the first segment 110. That is, at least part of the housing of the functional device may double as a part of the first antenna module 301, and the structure of the wireless mobile terminal can be further simplified. For example, the functional device may be a camera assembly, a fingerprint identification assembly, etc.

Although the present application is described with reference to the embodiments, various modifications can be made, and equivalents can be provided to substitute for the components thereof without departing from the scope of the present application. In particular, the features mentioned in the embodiments can be combined in any manner, provided that there is no structural conflict. The present application is not limited to the specific embodiments disclosed herein but includes all the solutions that fall within the scope of the claims.

What is claimed is:

1. An antenna apparatus, comprising:
a frame enclosing a hollow space and comprising a first segment extending in a first direction;
a bracket connected to a side of the first segment in a second direction and located in the hollow space, an extension dimension of the bracket in the first direction being greater than an extension dimension thereof in the second direction; and
an antenna assembly comprising a first antenna module, a material of the bracket and a material of the first segment each comprising a conductive material and reused as at least part of the first antenna module.

2. The antenna apparatus according to claim 1, further comprising a base plate, wherein the base plate is connected to the frame and encloses the hollow space together with the frame,
the bracket and the base plate are spaced apart from each other, or a grounding portion is connected to the bracket, the grounding portion abutting between the base plate and the bracket, and being electrically connected to the bracket and the base plate.

3. The antenna apparatus according to claim 2, wherein a reflective wall is arranged on a side of the bracket facing toward the base plate;
the reflective wall is connected to a side of the bracket facing toward or away from the first segment;
an extension dimension of the reflective wall in the first direction equals the extension dimension of the bracket in the first direction;
the reflective wall and the base plate are spaced apart from each other, or the reflective wall abuts between the base plate and the bracket; and
the reflective wall and the bracket are integrally formed.

4. The antenna apparatus according to claim 1, further comprising a connecting portion, wherein the connecting portion has one end connected to the first segment and the other end connected to the bracket, and the bracket and the first segment are spaced apart from each other in the second direction;
an extension dimension of the connecting portion in the second direction is smaller than the extension dimension of the bracket in the first direction;
the connecting portion extends in the second direction;
the first direction is perpendicular to the second direction; and
the connecting portion and the bracket are integrally formed.

5. The antenna apparatus according to claim 4, wherein the connecting portion comprises two first side faces oppositely arranged in the first direction, the bracket comprises a second side face facing toward the first segment, an included angle between an orthographic projection of the first side face in a third direction and a projection of the second side face in the third direction is 90 degrees, and the third direction is perpendicular to both of the first direction and the second direction;
the first segment comprises a third side face facing toward the bracket, and an included angle between the orthographic projection of the first side face in the third direction and a projection of the third side face in the third direction is 90 degrees; and
the orthographic projection of the second side face in the third direction is parallel to the projection of the third side face in the third direction.

6. The antenna apparatus according to claim 4, wherein the first segment and the bracket are both formed by extending in the first direction, and the connecting portion is formed by extending in the second direction, and the second direction is perpendicular to the first direction.

7. The antenna apparatus according to claim 4, further comprising an extension portion, wherein the extension portion is connected to a side of the bracket facing away from the first segment and extends in a direction away from the first segment;
an extension dimension of the extension portion in the second direction is smaller than the extension dimension of the bracket in the first direction;
the extension portion and the bracket are integrally formed;
the extension portion extends in the second direction; and
the first direction is perpendicular to the second direction.

8. The antenna apparatus according to claim 7, wherein the extension portion comprises two fourth side faces oppositely arranged in the first direction, the bracket comprises a second side face facing toward the first segment, an included angle between an orthographic projection of the fourth side face in a third direction and a projection of the second side face in the third direction is 90 degrees, and the third direction is perpendicular to both of the first direction and the second direction;
or the first segment and the bracket are both formed by extending in the first direction, and the extension portion is formed by extending in the second direction, and the second direction is perpendicular to the first direction.

9. The antenna apparatus according to claim 7, further comprising a connecting portion, wherein the connecting portion is connected between the first segment and the bracket, and the extension portion and the connecting portion are spaced apart from each other in the first direction.

10. The antenna apparatus according to claim 1, wherein the antenna assembly further comprises a second antenna module arranged on the bracket, the second antenna module comprising a plurality of second antenna elements; and
at least two of the second antenna elements are spaced apart from each other on the bracket in the first direction.

11. The antenna apparatus according to claim 10, further comprising a connecting portion, wherein the connecting portion has one end connected to the first segment and the other end connected to the bracket, and the bracket and the first segment are spaced apart from each other in the second direction,
at least one of the second antenna elements is arranged on the connecting portion; or at least two of the second antenna elements are spaced apart from each other on the connecting portion in the second direction.

12. The antenna apparatus according to claim 11, further comprising an extension portion, wherein the extension portion is connected to a side of the bracket facing away from the first segment and extends in a direction away from the first segment;
at least one of the second antenna elements is arranged on the extension portion; or at least two of the second antenna elements are spaced apart from each other on the extension portion in the second direction.

13. The antenna apparatus according to claim 10, wherein the second antenna module is a millimeter wave antenna module, and the second antenna elements are configured to transmit and receive millimeter wave antenna signal; and
the first antenna module is a non-millimeter wave antenna module, and the first antenna module is configured to transmit and receive a non-millimeter wave antenna signal.

14. The antenna apparatus according to claim 10, wherein the second antenna module comprises a substrate and a second integrated circuit, the substrate being arranged on the bracket, the second antenna elements being located on a side of the substrate facing away from the bracket, and the second integrated circuit being arranged on a side of the substrate facing toward the bracket; and
the second antenna module further comprises a shield, the shield and the substrate being connected to enclose an accommodating cavity, and the second integrated circuit being located in the accommodating cavity.

15. The antenna apparatus according to claim 14, wherein the second antenna module further comprises a connection terminal arranged on the side of the substrate facing toward the bracket, the connection terminal and the second integrated circuit being spaced apart from each other; and
the substrate comprises a first region and a second region connected to each other, the first region being located on the bracket, the second region protruding from the bracket, the second integrated circuit being arranged in the first region, and the connection terminal being arranged in the second region.

16. An antenna apparatus, comprising:
a frame enclosing a hollow space and comprising a first segment extending in a first direction;
a bracket connected to a side of the first segment in a second direction and located in the hollow space, a length direction of the bracket being not perpendicular to the first direction; and
an antenna assembly comprising a first antenna module, materials of the bracket and the first segment each comprising a conductive material and reusing as at least part of the first antenna module.

17. A wireless mobile terminal, comprising:
an antenna apparatus, comprising:
a frame enclosing a hollow space and comprising a first segment extending in a first direction;
a bracket connected to a side of the first segment in a second direction and located in the hollow space, an extension dimension of the bracket in the first direction being greater than an extension dimension thereof in the second direction; and
an antenna assembly comprising a first antenna module, a material of the bracket and a material of the first segment each comprising a conductive material and reused as at least part of the first antenna module.

18. The wireless mobile terminal according to claim 17, further comprising: a functional device, wherein a housing of the functional device is reused as at least part of the first segment; and
the functional device comprises at least one of a camera assembly and a fingerprint identification assembly.
